(19) United States
(12) Patent Application Publication
(10) Pub. No.: US 2025/0227464 A1
(43) Pub. Date: Jul. 10, 2025

(54) METHOD FOR IMPLEMENTING PRIVATE SET INTERSECTION PROTOCOL USING OBLIVIOUS PSEUDO-RANDOM FUNCTION BASED ON MINICRYPT, AND TERMINAL DEVICE USING SAME

(71) Applicant: SAMSUNG SDS CO., LTD., Seoul (KR)

(72) Inventors: Yongha SON, Seoul (KR); Seongkwang KIM, Seoul (KR); Byeonghak LEE, Seoul (KR); Kyoohyung HAN, Seoul (KR)

(73) Assignee: SAMSUNG SDS CO., LTD., Seoul (KR)

(21) Appl. No.: 19/005,316

(22) Filed: Dec. 30, 2024

(30) Foreign Application Priority Data
Jan. 10, 2024 (KR) 10-2024-0004318
Oct. 30, 2024 (KR) 10-2024-0150854

(51) Int. Cl. H04W 12/041; H04W 12/03; H04W 12/69

(52) U.S. Cl. CPC H04W 12/041; H04W 12/03; H04W 12/69

(57) ABSTRACT

A processor-implemented method including instructing a receiver to generate an OKVS (oblivious key-value store) matrix by applying an OKVS encoding algorithm to first data and hash data of the first data, generating a vector or scalar parameters satisfying a preset linear equation using vector oblivious linear evaluation (VOLE) for a subspace based on Minicrypt, and distributing a preset first group and a preset second group among the parameters to a sender and a receiver, respectively, instructing receiver to generate a masking matrix by masking the OKVS matrix to a first vector included in the first group and transmit the masking matrix to the sender, instructing the sender to update one of the vectors included in the second group using the masking matrix, and instructing the receiver to generate first comparison data by applying an OKVS decoding algorithm to a second vector included in the first group and the first data.

### CROSS-REFERENCE TO RELATED APPLICATION(S)

This application claims the benefit under 35 USC § 119 (a) of Korean Patent Applications No. 10-2024-0004318, filed on Jan. 10, 2024, and No. 10-2024-0150854, filed on Oct. 30, 2024, in the Korean Intellectual Property Office, the entire disclosure of which is incorporated herein by reference for all purposes.

### BACKGROUND

### 1. Field

The present disclosure relates to a method for implementing a private set intersection (PSI) protocol for personal information protection or the like using an oblivious pseudo-random function based on Minicrypt, and a terminal device using the same.

### 2. Description of the Related Art

Various recent regulations related to personal information protection are sparking interest in privacy-enhancing technologies (PETs) capable of protecting personal information while performing necessary analysis.

Among privacy-enhancing technologies, the PSI (private set intersection) protocol is a protocol that supports two terminals in calculating the intersection between data sets without disclosing their own data. Currently, the PSI protocol is being utilized in various applications.

In addition, the oblivious pseudo-random function (OPRF) protocol is a protocol in which a receiver obtains a pseudo-random value {F(x₁), . . . , F(xₙ)} for its input data {x₁, . . . , xₙ} and in which a sender obtains a pseudo-random function F.

In general, the PSI protocol may be implemented based on the OPRF, and to this end, the sender may generate a pseudo-random function value for all elements of its own set using the pseudo-random function and transmit it to the receiver.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including instructing a receiver to generate an OKVS (oblivious key-value store) matrix by applying an OKVS encoding algorithm to first data and hash data of the first data, generating a vector or scalar parameters satisfying a preset linear equation using vector oblivious linear evaluation (VOLE) for a subspace based on Minicrypt, and distributing a preset first group and a preset second group among the parameters to a sender and a receiver, respectively, instructing receiver to generate a masking matrix by masking the OKVS matrix to a first vector included in the first group and transmit the masking matrix to the sender, instructing the sender to update one of the vectors included in the second group using the masking matrix, and instructing the receiver to generate first comparison data by applying an OKVS decoding algorithm to a second vector included in the first group and the first data.

The generating of the OKVS matrix may include generating the OKVS matrix, the OKVS matrix being a binary matrix having a size of (1+ε)·n× [symbol] , where n and [symbol] are natural numbers, and ε is a real number greater than or equal to 0, by applying the OKVS encoding algorithm to n pieces of first data having [symbol] bits and hash data obtained by applying a first hash function to the first data.

The method may include instructing the receiver to apply a linear code encoder to the OKVS matrix to convert the OKVS matrix into a linear matrix, the linear code being configured to perform a linear operation.

The generating of the OKVS matrix may include generating the OKVS matrix, the OKVS matrix being a binary matrix having a size of (1+ε)·n× [symbol] , where n and [symbol] are natural numbers, and ε is a real number greater than or equal to 0, by applying the OKVS encoding algorithm to n pieces of first data having [symbol] bits and hash data obtained by applying a first hash function to the first data, the converting into the linear matrix including generating a linear matrix having a size of (1+ε)·n×nc by applying the linear code encoder to each row of the OKVS matrix, and parameters nc, kc, and dc are preset for the linear code encoder such that nc−kc= [symbol] such that each row in the linear matrix has at least dc elements having non-zero values, and such that dc is set to satisfy f×dc≥k for the number of bits (f) corresponding to a field including elements of the second vector and a security coefficient (k).

The distributing may include distributing the first group to the receiver and distributing the second group to the sender, the linear equation being V\vec{ }⊕W\vec{ }=Δ·U\vec{ }, where Δ is an element of a predefined field F, V and W are vectors including elements of the predefined field F, and U is a vector belonging to a subspace of a vector space where respective elements of the vector include elements of the predefined field F, the first group includes V and U, and the second group includes W and Δ.

The transmitting the masking matrix to the sender may include instructing the receiver to generate a vector Z, the vector Z being a masking matrix obtained by masking the vector U to the OKVS matrix using exclusive OR (XOR), and to transmit the vector Z to the sender.

The updating may include instructing the sender to update the vector W using the vector Z.

The updating may include updating the vector W using (W′)\vec{ }=W\vec{ }⊕Z\vec{ }·Diag(Δ), where W′ is the updated vector W, and Diag(Δ) is a diagonal matrix whose diagonal components including scalar values Δ.

The generating of the first comparison data may include instructing the receiver to generate the first comparison data by applying the first data and the vector V to the OKVS decoding algorithm.

The method may include instructing the sender to define a pseudo-random function based on the OKVS decoding algorithm using the updated vector and instructing the sender to apply second data of the sender and parameters in the second group to the pseudo-random function to generate second comparison data.

The generating of the second comparison data may include instructing the sender to define a pseudo-random function according to the OKVS decoding algorithm from a relationship between the vector V and the updated W′, responsive to the linear equation being V\vec{ }⊕W\vec{ }=Δ·U\vec{ }, where A is an element of a predefined field F, V and W are vectors including elements of the predefined field F, and U is a vector belonging to a subspace of a vector space where respective elements of the vector include the elements of the predefined field F, when the first group includes V and U, and when the second group includes W and Δ, and instructing the sender to apply second data, Δ, and the updated W′ to the pseudo-random function to generate the second comparison data.

The generating of the second comparison data may include, when the linear equation is V\vec{ }⊕W\vec{ }=Δ·U\vec{ }, where Δ is an element of a predefined field F, V and W are vectors include elements of the predefined field F, and U is a vector belonging to a subspace of a vector space where respective elements of the vector include the elements of the predefined field F, when the first group includes V and U, and when the second group includes W and Δ, defining the pseudo-random function using PRF(x):=H0(OKVS·Decode(W′, x)+Δ·C(H(x))), where PRF( ) is the pseudo-random function, x is the second data, OKVS·Decode( ) is an OKVS decoding function, W′ is the updated vector W, C( ) is a linear matrix by a linear code encoder, H( ) is a first hash function, and H0( ) is a second hash function.

The method may include determining an intersection between the first data of the receiver and the second data of the sender using the first comparison data and the second comparison data.

In a general aspect, here is provided a non-transitory computer-readable storage medium storing instructions that, when executed by a processor, cause the processor to perform the method.

In a general aspect, here is provided a receiver, the receiver including one or more processors configured to execute instructions, a memory storing the instructions, which when executed by the processor configure the processor to generate an OKVS (oblivious key-value store) matrix by applying an OKVS encoding algorithm to first data and hash data of the first data, apply a linear code encoder to the OKVS matrix to convert the OKVS matrix into a linear matrix including a linear code configured to perform a linear operation, receive a preset first group distributed, among vector or scalar parameters responsive to the vector or scalar parameters satisfying a preset linear equation being generated using vector oblivious linear evaluation (VOLE) for a subspace based on Minicrypt, generate a masking matrix by masking the linear matrix to a first vector included in the first group and transmitting the masking matrix to a sender, and generate first comparison data by applying an OKVS decoding algorithm to a second vector included in the first group and the first data.

The one or more processors may be further configured to generate, when the linear equation is V\vec{ }⊕W\vec{ }=Δ·U\vec{ }, where Δ is an element of a predefined field F, V and W are vectors including elements of the predefined field F, and U is a vector belonging to a subspace of a vector space where respective elements of the vector include the elements of the predefined field F, and when the first group includes V and U, and a second group includes W and Δ, a vector Z, the vector Z being a masking matrix obtained by masking the vector U to the linear matrix using exclusive OR (XOR), and transmit the vector Z to the sender.

The one or more processors may be further configured to generate the first comparison data by applying the first data and the vector V to the OKVS decoding algorithm.

In a general aspect, here is provided a sender including one or more processors configured to execute instructions, a memory storing the instructions, which when executed by the processor configure the processor to receive a preset second group distributed, among vector or scalar parameters responsive to the vector or scalar parameters satisfying a preset linear equation being generated using vector oblivious linear evaluation (VOLE) for a subspace based on Minicrypt, update one vector of the vectors included in the second group using a masking matrix responsive to the masking matrix being obtained by masking a first vector included in a first group being received from a receiver, and define a pseudo-random function according to an OKVS (oblivious key-value store) decoding algorithm using the updated one vector and apply second data and parameters in the second group to the pseudo-random function to generate second comparison data.

The one or more processors may be further configured to update a vector W using (W′)\vec{ }=W\vec{ }⊕Z\vec{ }Diag(Δ), where W′ is an updated vector W, Z is the masking matrix, and Diag(Δ) is a diagonal matrix having scalar values Δ, responsive to the linear equation being V\vec{ }⊕W\vec{ }=Δ·U\vec{ }, where Δ is an element of a predefined field F, V and W are vectors including elements of the predefined field F, and U is a vector belonging to a subspace of a vector space where respective elements of the U vector include the elements of the predefined field F, the first group includes V and U, and the second group includes W and Δ.

The one or more processors, in generating the second comparison data, may be further configured to define the pseudo-random function using PRF(x):=H0(OKVS·Decode (W′, x)+Δ·C(H(x))), where PRF( ) is the pseudo-random function, x is the second data, OKVS·Decode( ) is an OKVS decoding function, W′ is the updated vector W, C( ) is a linear matrix, H( ) is a first hash function, and H0( ) is a second hash function.

### BRIEF DESCRIPTION OF THE DRAWINGS

FIG. 1 is a schematic diagram illustrating a PSI protocol between a receiver and a sender according to an embodiment of the present disclosure.

FIG. 2 is a schematic diagram illustrating a PSI protocol using an OPRF according to an embodiment of the present disclosure.

FIG. 3 is a schematic diagram illustrating a PSI protocol using a subspace OPRF based on Minicrypt according to an embodiment of the present disclosure.

FIG. 4 is a block diagram illustrating a computing environment suitable for use in exemplary embodiments of the present disclosure.

FIG. 5 is a flowchart illustrating a method for implementing a PSI protocol using a Minicrypt-based OPRF according to an embodiment of the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

As used in connection with various example embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one embodiment, the module may be implemented in a form of an application-predetermined integrated circuit (ASIC).

As used herein, the term “˜unit” refers to a software or hardware component such as a field-programmable gate array (FPGA) or an application-specific integrated circuit (ASIC) and the “˜unit” performs predefined functions. However, the “˜unit” is not limited to software or hardware. The “˜unit” may be configured to be on an addressable storage medium or configured to operate one or more processors. For example, the “˜unit” may include components such as software components, object-oriented software components, class components, and task components, processes, functions, attributes, procedures, subroutines, segments of program code, drivers, firmware, microcode, circuits, data, database, data structures, tables, arrays, and variables. The functionality provided by the components and the “˜unit” may be combined into fewer components and “˜units” or further separated into additional components and “˜units”. In addition, components and “˜units” may be implemented to play one or more central processing units (CPU) in a device or secure multimedia card. The “˜unit” may include one or more processors.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

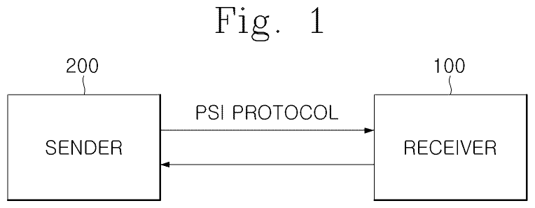

FIG. 1 is a schematic diagram illustrating a PSI protocol between a receiver and a sender according to an embodiment of the present disclosure.

Referring to FIG. 1, the PSI protocol according to an embodiment of the present disclosure may be performed between a receiver 100 and a sender 200.

Hereinafter, the PSI protocol according to an embodiment of the present disclosure will be described with reference to FIG. 1.

The receiver 100 and the sender 200 may be connected using a wired or wireless network and may perform a PSI (private set intersection) protocol. That is, using the PSI protocol, the receiver 100 and the sender 200 may calculate the intersection between their respective data without disclosing their own data to each other.

Here, the receiver 100 and the sender 200 are distinguished, which may be divided according to the function performed by a terminal device. That is, the receiver 100 and the sender 200 may be implemented using a terminal device, respectively. In addition, one terminal device may operate as the receiver 100 or the sender 200 depending on the situation. Depending on the embodiment, the receiver 100 and the sender 200 may be a server and a client, respectively, but are not limited thereto.

The terminal device may include a communication module for transmitting and receiving information, a memory for storing programs and protocols, a processor for executing various programs for calculations and controls.

Here, the terminal device may be a mobile terminal such as a smartphone or a tablet PC, or a fixed terminal such as a desktop. For example, the terminal device may include a mobile phone, a smartphone, a laptop computer, a digital broadcasting terminal, a PDA (personal digital assistant), a PMP (portable multimedia player), a slate PC, a tablet PC, an ultra-book, a wearable device (e.g., a smartwatch, smart glasses, or an HMD (head-mounted display)), or the like.

The network between the receiver 100 and the sender 200 may be a wired network or a wireless network, and specifically, may include various networks such as a local area network (LAN), a metropolitan area network (MAN), and a wide area network (WAN). In addition, the network may include the known World Wide Web (WWW). However, the network according to the present disclosure is not limited to the networks listed above, and may include a known wireless data network, a known telephone network, a known wired or wireless television network, and the like.

The PSI protocol may be implemented using an oblivious pseudo-random function (OPRF) between the receiver 100 and the sender 200. Using the OPRF, the receiver 100 may obtain pseudo-random values {F(x₁), F(x₂), . . . , F(xₙ)} for its own input data {x₁, x₂, . . . , xₙ}, and the sender 200 may obtain a pseudo-random function F.

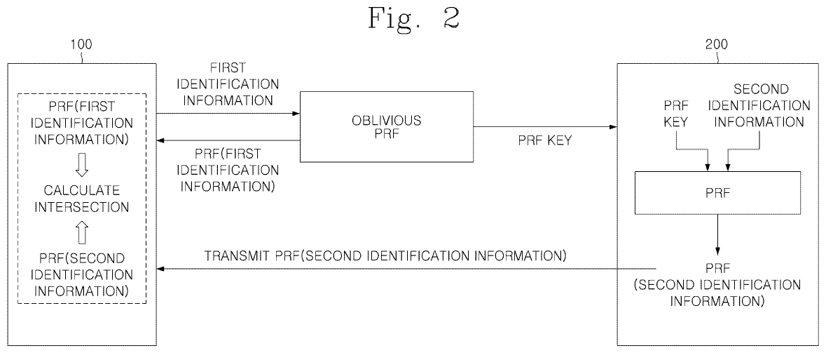

That is, referring to FIG. 2, if the receiver 100 inputs its first identification information, the OPRF may generate first comparison data “PRF (first identification information)” corresponding thereto, and provide it to the receiver 100. In addition, the sender 200 may be provided with a PRF key that defines a PRF (pseudo-random function) used when generating the corresponding “PRF (first identification information)”. Therefore, the sender 200 may generate a PRF function using the PRF key, and then input its second identification information into the PRF function, thereby generating second comparison data “PRF (second identification information)”.

Afterwards, the sender 200 may provide the “PRF (second identification information)” to the receiver 100, and the receiver 100 may compare the “PRF (first identification information)” and the “PRF (second identification information)” to determine whether or not there is an intersection. That is, since the “PRF (first identification information)” and the “PRF (second identification information)” are generated based on the same PRF function, if the first identification information and the second identification information are the same, the “PRF (first identification information)” and the “PRF (second identification information)” also have the same value. Therefore, the receiver 100 may find the intersection between the first identification information and the second identification information by comparing the “PRF (first identification information)” and the “PRF (second identification information)”.

Here, since the receiver 100 is not aware of the PRF key information, the receiver 100 may regard the “PRF (second identification information)” provided from the sender 200 as a random value. That is, the receiver 100 is unable to identify the second identification information from the “PRF (second identification information)”. In addition, since the sender 200 receives only the PRF key, it is impossible to identify any information about the first identification information of the receiver 100. As described above, using the OPRF, it is possible to implement a PSI protocol enabling calculation of the intersection between respective data without the receiver 100 and the sender 200 disclosing their data to each other.

Depending on the embodiment, it is also possible to implement the PSI protocol using an OPRF using Minicrypt based only on the assumption that a one-way function exists. Here, although an OPRF-based PSI protocol with higher security may be implemented when applying vector oblivious linear evaluation (VOLE) and OKVS (oblivious key value store), it may bring about problems such as a larger amount of communication required between the receiver 100 and the sender 200. In addition, a method of applying VOLE based on LPN (learning parity with noise), instead of Minicrypt, has been proposed, but in this case, although efficient data transmission is possible, there may be a problem with security because it is based on the LPN problems.

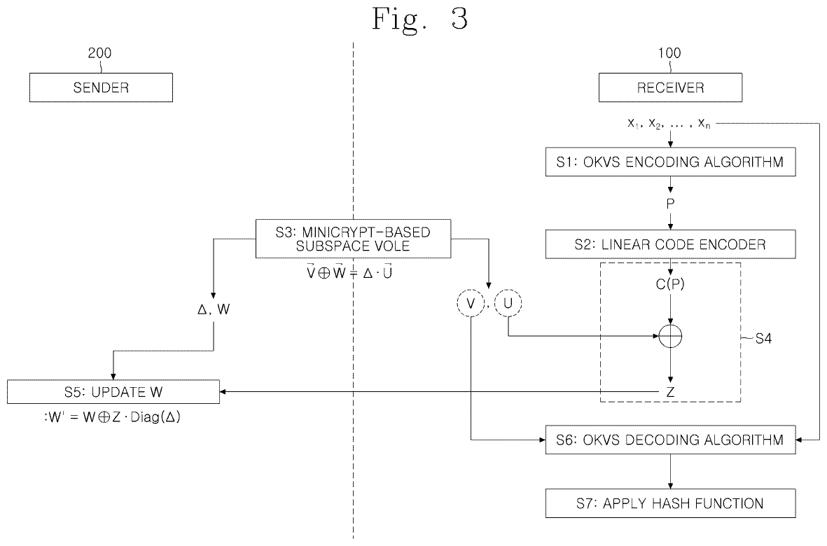

Therefore, an embodiment of the present disclosure proposes a method for implementing a PSI protocol using VOLE and OKVS based on Minicrypt with high security while reducing the amount of communication required. In addition, since the amount of communication and computation between the sender 200 and the receiver 100 may be adjusted, adaptive operation is possible depending on the network environment or the like. Hereinafter, the operation of the receiver 100 and the sender 200 according to an embodiment of the present disclosure will be described with reference to FIG. 3.

FIG. 3 is a schematic diagram illustrating a PSI protocol using a subspace OPRF based on Minicrypt according to an embodiment of the present disclosure.

Referring to FIG. 3, the receiver 100 may generate an OKVS matrix by applying an OKVS (oblivious key-value store) encoding algorithm to first data and the hash data of the first data (S1). The receiver 100 may have first data (x₁, x₂, . . . , xₙ) stored therein and generate hash data (y₁, y₂, . . . , yₙ) by applying a first hash function to the first data (x₁, x₂, . . . , xₙ). Here, the first data may be regarded as a key, and the hash data may be regarded as a value, and an OKVS matrix P may be generated from the key and the value using OKVS encoding. That is, OKVS·Encode ((x₁, x₂, . . . , xₙ), (y₁, y₂, . . . , yₙ))=P, where P corresponds to the OKVS matrix.

Here, if the first data is n pieces of data having l bits, the OKVS matrix P may be generated as a binary matrix having a size of (1+ε)·n×l (n and l are natural numbers, and ε is a real number equal to or greater than 0). That is, the encoding data for the key and the value may be generated to have l bits and then stored in the row of the OKVS matrix. In addition, the encoding data may be generated more than n corresponding to the number of respective keys and values. That is, the number of pieces of encoding data may be determined depending on the encoding efficiency and storage space, and the number of pieces of encoding data added to the OKVS matrix may be determined by ε. ε is a parameter representing the overhead ratio of OKVS, and may be set to, for example, 0.1 to 0.3.

Meanwhile, when the OKVS matrix and the key are input, the OKVS decoding algorithm may return a value corresponding thereto. That is, OKVS·Decode(P, xᵢ)=yᵢ. Here, if the key and the value are the first data and the first hash data, respectively, the OKVS decoding algorithm may return hash data corresponding to the OKVS matrix and each piece of the first data. Here, since the OKVS decoder has linear properties, OKVS·Decode(P1+P₂, X)=OKVS·Decode(P₁, x)+OKVS·Decode(P₂, x) may be established.

Afterwards, the receiver 100 may apply a linear code encoder to the OKVS matrix P to convert the OKVS matrix P into a linear matrix C(P) including a linear code capable of linear operation (S2) (i.e., the linear code is configured to perform the linear operation).

Specifically, the receiver 100 may apply a linear code encoder to each row of the OKVS matrix P to generate a linear matrix having a size of (1+ε)·n×n_{c}. Here, the parameters n_{c}, k_{c}, and d_{c} may be preset for the linear code encoder, and may be configured such that n_{c}−k_{c}= [symbol] such that each row in the linear matrix has at least do elements having non-zero values, and such that d_{c} is set to satisfy f×d_{c}≥k for the number of bits (f) corresponding to the field and the security coefficient (k). That is, the linear code encoder receives an input of a vector in nc-k_{c} dimensions and outputs a vector of n_{c} dimensions, and the output vector may be configured to have at least d_{c} elements having non-zero values.

Here, the security of the PSI protocol using the OPRF may be determined according to the size of d_{c}. d_{c} may be set to satisfy f×d_{c}≥k for the number of bits (f) of the field in which each element of vector V exists in the subspace VOLE described below and the security coefficient (k) that is preset. At this time, the field is a binary field, and the number of bits (f) of the field (F) may be generated using f=log₂|F| for the field F of the vector V. k may be set to 128, 192, 256, etc., and when f=1 and k=128, the d_{c} of the linear code encoder may be set to 128.

According to an embodiment of the present disclosure, since the size ratios among the vector U, the field where the elements of vector V exist, and the subspace in the subspace VOLE may be adjusted, it is possible to adjust f. Here, if f is adjusted, it is possible to use a smaller d_{c}, and in this case, n_{c} may also be reduced. In this case, since the data size of the linear matrix C(P) is relatively reduced, it is possible to reduce the amount of communication required during protocol execution. That is, f may be adjusted according to the size of the subspace, thereby reducing the amount of communication between the receiver 100 and the sender 200 according thereto.

Additionally, the function L corresponding to the linear code encoder may have linear properties. That is, L(x₁)+L(x₂)=L(x₁+x₂) may be established.

Afterwards, using VOLE for the subspace based on Minicrypt, a vector or scalar parameters satisfying a preset linear equation may be generated (S3). Here, the sender 200 and the receiver 100 may be assigned a preset first group and a preset second group among the parameters.

Specifically, the linear equation may be \vec{V}⊕\vec{W}=Δ·\vec{U}, where Δ is an element of a predefined field F, V and W are vectors comprised of elements of the corresponding field F, and U may correspond to a vector belonging to a subspace B of a vector space where respective elements of the vector are comprised of the elements of the field F. Depending on the embodiment, Δ may be an n_{c}-dimensional vector comprised of elements of the field F, V and W may be an m×n_{c} matrix comprised of elements of the field F, and U may be an m×n_{c} matrix in which respective columns are elements of the subspace B. Here, the field F may be a binary field, and n_{c} may be a parameter n_{c} of a linear code encoder. At this time, the first group includes vectors V and U, and the second group includes W and Δ, and the receiver 100 may be assigned the first group and the sender 200 may be assigned the second group, respectively.

Here, the size of subspace B may be adjusted for the entire field F, and this enables adjustment of the number of bits (f) of the entire field F. That is, it is possible to adjust the trade-off between the amount of communication and the amount of computation by adjusting the ratio of the sizes of the spaces where the elements of U and V exist. Depending on the embodiment, the size of the linear matrix output by the linear code encoder may be reduced three times or more, based on the same security, thereby drastically reducing the amount of communication. In addition, it is also possible to reduce the protocol execution time, instead of increasing the amount of communication, in a smooth network environment.

Meanwhile, in the VOLE for the subspace based on Minicrypt, V, W, Δ, and U satisfying the corresponding linear equation may be arbitrarily generated. Therefore, V, W, Δ, and U may be generated before the receiver 100 generates the OKVS matrix P or linear matrix C(P) for the first data (x₁, x₂, . . . , xₙ) and distributed to the receiver 100 and the sender 200, respectively. In addition, depending on the embodiment, it is also possible to generate V, W, Δ, and U at the same time at which the OKVS matrix P or linear matrix C(P) of the receiver 100 is generated, and distribute the same.

The receiver 100 may generate a masking matrix Z by masking the linear matrix C(P) to the first vector included in the first group, and transmit the generated masking matrix Z to the sender 200 (S4). That is, the receiver 100 may mask the vector U corresponding to the first vector to the linear matrix C(P) with exclusive OR (XOR), thereby generating a vector Z, which is a masking matrix. Here, in order to prevent recognizing information of the linear matrix C(P) from the vector Z, the data of the vector U and linear matrix C(P) may be generated to have the same size. Thereafter, the receiver 100 may transmit the vector Z to the sender 200, so that the sender 200 may be provided with information necessary to define a pseudo-random function.

The sender 200 may update one of the vectors included in the second group using the masking matrix (S5). That is, the sender 200 may update the vector W using the vector Z, and specifically, may update the vector W using \vec{W}′=\vec{W}⊕\vec{Z}·Diag(Δ). Here, W′ is the updated vector W, and Diag(Δ) is a diagonal matrix whose diagonal components have scalar values Δ. In this case, V=W′+Δ·C(P) is satisfied.

Afterwards, the receiver 100 may apply the OKVS decoding algorithm to the second vector included in the first group and the first data to generate first comparison data (S6). That is, the receiver 100 may apply the first data and the vector V corresponding to the second vector to the OKVS decoding algorithm. Depending on the embodiment, the first comparison data may be generated by further applying a second hash function to the result data of OKVS decoding (S7). At this time, the second hash function may be utilized as a function different from the first function applied to the first data.

Specifically, the first comparison data may be generated as follows.

resultᵢ=H⁰(OKVS·Decode(V,xᵢ)) for i=1, . . . , n

Here, resultᵢ is the first comparison data, H⁰( ) is the second hash function, OKVS·Decode( ) is the OKVS decoding algorithm, and xᵢ is the first data. That is, the receiver 100 may apply the second hash function to the result value of calculating the vector V and the first data according to the OKVS decoding algorithm, thereby generating the first comparison data.

Meanwhile, the sender may define a pseudo-random function based on the OKVS decoding algorithm using the updated vector, and may generate second comparison data by applying the second data of the sender 200 and the parameters in the second group to the pseudo-random function.

That is, the sender 200 may define a pseudo-random function according to the OKVS decoding algorithm using the relationship between the vector V and the updated W′, and may generate the second comparison data by applying the second data, Δ, and the updated W′ to the pseudo-random function.

Specifically, the pseudo-random function may be defined as the following Equation.

$$PRF ( x ) := {H}^{0} ( OKVS . Decode ( {W}^{′} , x ) + Δ \cdot C ( H ( x ) ) )$$

Here, PRF( ) is the pseudo-random function, x is the second data, OKVS·Decode( ) is the OKVS decoding function, W′ is the updated vector W, C( ) is a linear matrix, H( ) is the first hash function, and H⁰( ) may be the second hash function.

Specifically, since V=W′+Δ·C(P), the pseudo-random function may be obtained as follows.

$$\begin{matrix}{H}^{0} ( OKVS . Decode ( V , {x}_{i} ) ) = {H}^{0} ( OKVS . Decode ( {W}^{′} + Δ \cdot C ( P ) , {x}_{i} ) ) \\ = {H}^{0} ( OKVS . Decode ( {W}^{′} , {x}_{i} ) + \\ + Δ \cdot C ( OKVS . Decode ( P , {x}_{i} ) ) \\ = {H}^{0} ( OKVS . Decode ( {W}^{′} , {x}_{i} ) + Δ \cdot C ( H ( {x}_{i} ) ) )\end{matrix}$$

Here, since the sender 200 is aware of W′ and Δ, it is possible to obtain a pseudo-random function value for any input data x. That is, the sender 200 may add the result value of inputting W′ and the second data to the OKVS decoding algorithm to the result of multiplying the result of hashing the second data with the first hash function by Δ to obtain the pseudo-random function value, thereby generating the second comparison data.

Afterwards, the receiver 100 or the sender 200 may determine the intersection between the first data and the second data using the first comparison data and the second comparison data. That is, since the first comparison data and the second comparison data have the same value if the first data and the second data are the same, it is possible to find the intersection between the first data and the second data using the first comparison data and the second comparison data. Specifically, Δ·C(OKVS·Decode(P, xᵢ)) of the pseudo-random function may be converted to Δ·C(H(xᵢ)) only when xᵢ corresponds to the first data. Therefore, the first comparison data and the second comparison data may match only when the first data and the second data are the same.

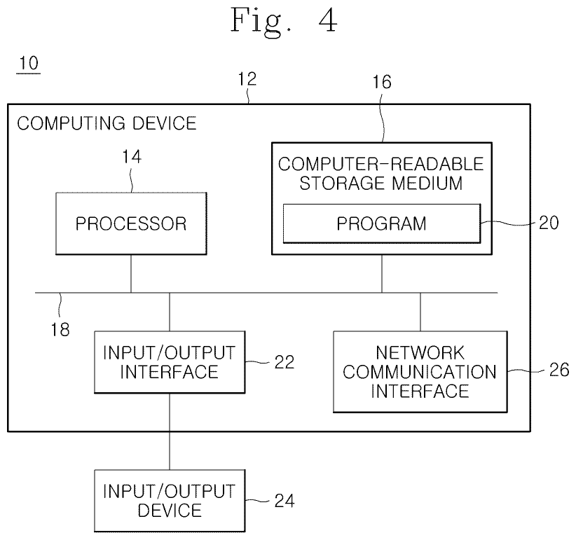

FIG. 4 is a block diagram illustrating a computing environment 10 suitable for use in exemplary embodiments of the present disclosure. In the illustrated embodiment, respective components may have functions and capabilities other than those described below and further include other components in addition to those described below.

The illustrated computing environment 10 includes a computing device 12. In an embodiment, the computing device 12 may be the receiver 100 or the sender 200.

The computing device 12 includes at least one processor 14, a computer-readable storage medium 16, and a communication bus 18. The processor 14 may cause the computing device 12 to operate according to the exemplary embodiments described above. For example, the processor 14 may execute one or more programs stored on the computer-readable storage medium 16. The one or more programs may include one or more computer-executable instructions, and the computer-executable instructions may be configured to cause, when executed by the processor 14, the computing device 12 to perform operations according to the exemplary embodiments.

The computer-readable storage medium 16 is configured to store computer-executable instructions, program code, program data, and/or other suitable forms of information. Programs 20 stored on the computer-readable storage medium 16 include a set of instructions executable by the processor 14. In an embodiment, the computer-readable storage medium 16 may be memory (volatile memory such as random access memory, nonvolatile memory, or a suitable combination thereof), one or more magnetic disk storage devices, optical disk storage devices, flash memory devices, any other form of storage medium capable of being accessed by the computing device 12 and storing desired information, or a suitable combination thereof.

The communication bus 18 interconnects the processor 14, the computer-readable storage medium 16, and other various components of the computing device 12.

The computing device 12 may also include one or more input/output interfaces 22 that provide interfaces for one or more input/output devices 24 and one or more network communication interfaces 26. The input/output interfaces 22 and the network communication interfaces 26 are connected to the communication bus 18. The input/output devices 24 may be connected to other components of the computing device 12 via the input/output interfaces 22. The input/output devices 24 may include, for example, input devices such as pointing devices (mouse or trackpad), keyboards, touch input devices (touchpad or touchscreen), voice or sound input devices, various types of sensor devices, and/or photographing devices, and/or output devices such as display devices, printers, speakers, and/or network cards. The exemplary input/output devices 24 may be included in the computing device 12 as components that constitute the computing device 12, or may be configured as separate devices from the computing device 12 so as to be connected to the computing device 12.

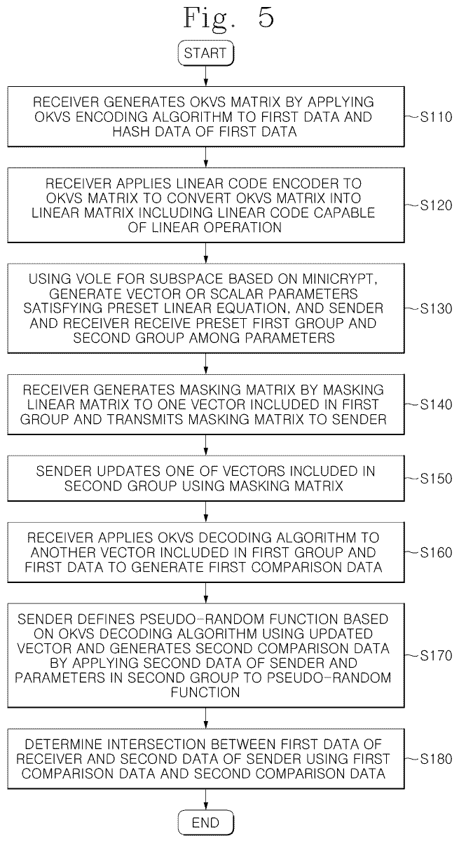

FIG. 5 is a flowchart illustrating a method for implementing a PSI protocol using a Minicrypt-based OPRF according to an embodiment of the present disclosure. Here, respective steps in FIG. 5 may be performed by a receiver or a sender according to an embodiment of the present disclosure.

Referring to FIG. 5, the receiver may generate an OKVS matrix by applying an OKVS encoding algorithm to first data and the hash data of the first data (S110). The receiver may have first data (x₁, x₂, . . . , xₙ) stored therein and generate hash data (y₁, y₂, . . . , yₙ) by applying a first hash function to the first data (x₁, x₂, . . . , xₙ). Here, an OKVS matrix P may be generated from the first data and the hash data using OKVS encoding. That is, OKVS·Encode((x₁, x₂, . . . , xₙ), (y₁, y₂, . . . , yₙ))=P, where P corresponds to the OKVS matrix.

Here, if the first data is n pieces of data having [symbol] bits, the OKVS matrix P may be generated as a binary matrix having a size of (1+ε)·n× [symbol] (n and [symbol] are natural numbers, and ε is a real number equal to or greater than 0). That is, the encoding data may be generated more than n corresponding to the number of pieces of first data. The number of pieces of encoding data added to the OKVS matrix may be determined by ε. ε is a parameter representing the overhead ratio of OKVS, and may be set to, for example, 0.1 to 0.3.

The receiver may apply a linear code encoder to the OKVS matrix to convert the OKVS matrix into a linear matrix including a linear code capable of linear operation (S120). Specifically, the receiver may apply a linear code encoder to each row of the OKVS matrix P to generate a linear matrix having a size of (1+ε)·n×n_{c}. Here, the parameters n_{c}, k_{c}, and d_{c} may be preset for the linear code encoder, and may be configured such that n_{c}−k_{c}= [symbol] , such that each row in the linear matrix has at least d_{c} elements having non-zero values, and such that d_{c} is set to satisfy f×d_{c}≥k for the number of bits (f) corresponding to the field and the security coefficient (k). Here, the security of the PSI protocol using the OPRF may be determined according to the size of d_{c}. That is, f may be adjusted according to the size of the subspace, so that the sizes of d_{c} and n_{c} may be adjusted, thereby reducing the amount of communication between the receiver 100 and the sender 200.

Afterwards, using VOLE for the subspace based on Minicrypt, a vector or scalar parameters satisfying a preset linear equation may be generated, and the sender and the receiver may be assigned a preset first group and a preset second group among the parameters (S130).

Specifically, the linear equation may be \vec{V}⊕\vec{W}=Δ·\vec{U}, where Δ is an element of a predefined field F, V and W are vectors comprised of elements of the corresponding field F, and U may correspond to a vector belonging to a subspace B of a vector space where respective elements of the vector are comprised of the elements of the field F. Here, the first group includes vectors V and U, and the second group includes W and Δ, and the receiver may be assigned the first group and the sender may be assigned the second group, respectively.

In the VOLE for the subspace based on Minicrypt, V, W, Δ, and U satisfying the corresponding linear equation may be arbitrarily generated. Therefore, V, W, Δ, and U may be generated before the receiver generates the OKVS matrix P or linear matrix C(P) for the first data (x₁, x₂, . . . , xₙ) and distributed to the receiver and the sender, respectively. In addition, depending on the embodiment, it is also possible to generate V, W, Δ, and U at the same time at which the OKVS matrix P or linear matrix C(P) of the receiver is generated, and distribute the same.

Afterwards, the receiver may generate a masking matrix by masking the OKVS matrix to the first vector included in the first group, and transmit the generated masking matrix to the sender (S140). That is, the receiver may mask the vector U corresponding to the first vector to the linear matrix C(P) with exclusive OR (XOR), thereby generating a vector Z, which is a masking matrix. Here, in order to prevent recognizing information of the linear matrix C(P) from the vector Z, the data of the vector U and linear matrix C(P) may be generated to have the same size. Thereafter, the receiver may transmit the vector Z to the sender, so that the sender may be provided with information necessary to define a pseudo-random function.

The sender may update one of the vectors included in the second group using the masking matrix (S150). That is, the sender may update the vector W using the vector Z, and specifically, may update the vector W using \vec{W}′=\vec{W}⊕\vec{Z}·Diag(Δ). Here, W′ is the updated vector W, and Diag(Δ) is a diagonal matrix whose diagonal components have scalar values Δ. In this case, V=W′+Δ·C(P) is satisfied.

The receiver may apply the OKVS decoding algorithm to the second vector included in the first group and the first data to generate first comparison data (S160). That is, the receiver may apply the first data and the vector V corresponding to the second vector to the OKVS decoding algorithm. Depending on the embodiment, the first comparison data may be generated by further applying a second hash function to the result data of OKVS decoding. At this time, the second hash function may be utilized as a function different from the first function applied to the first data.

Specifically, the first comparison data may be generated as follows.

resultᵢ=H⁰(OKVS·Decode(V,xᵢ)) for i=1, . . . ,n

Here, resultᵢ is the first comparison data, H⁰( ) is the second hash function, OKVS·Decode( ) is the OKVS decoding algorithm, and xᵢ is the first data. That is, the receiver may apply the second hash function to the result value of calculating the vector V and the first data according to the OKVS decoding algorithm, thereby generating the first comparison data.

The sender may define a pseudo-random function based on the OKVS decoding algorithm using the updated vector, and may generate second comparison data by applying the second data of the sender and the parameters in the second group to the pseudo-random function (S170).

That is, the sender may define a pseudo-random function according to the OKVS decoding algorithm using the relationship between the vector V and the updated W′, and may generate the second comparison data by applying the second data, Δ, and the updated W′ to the pseudo-random function.

Specifically, the pseudo-random function may be defined as the following Equation.

$$PRF ( x ) := {H}^{0} ( OKVS . Decode ( {W}^{′} , x ) + Δ \cdot C ( H ( x ) ) )$$

Here, PRF( ) is the pseudo-random function, x is the second data, OKVS·Decode( ) is the OKVS decoding function, W′ is the updated vector W, C( ) is a linear matrix, H( ) is the first hash function, and H⁰( ) may be the second hash function. Since the sender is aware of W′ and Δ, it is possible to obtain a pseudo-random function value for any input data x.

That is, the sender may add the result value of inputting W′ and the second data to the OKVS decoding algorithm to the result of multiplying the result of hashing the second data with the first hash function by A, thereby generating the second comparison data by applying the second hash function.

The intersection between the first data of the receiver and the second data of the sender may be determined using the first comparison data and the second comparison data (S180). That is, since the first comparison data and the second comparison data have the same value if the first data and the second data are the same, it is possible to find the intersection between the first data and the second data using the first comparison data and the second comparison data. Here, determining the intersection using the first comparison data and the second comparison data may be performed in the receiver or the sender.

The processors, memories, neural networks, receiver 100, sender 200, computing environment 10, computing device 12, the at least one processor 14, a computer-readable storage medium 16, and a communication bus 18, the one or more input/output interfaces 22, the one or more input/output devices 24, and one or more network communication interfaces 26 described herein and disclosed herein described with respect to FIGS. 1-5 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROM, DVD-Rs, DVD+Rs, DVD-RWs, DVD+RWs, DVD-RAMS, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
instructing a receiver to generate an OKVS (oblivious key-value store) matrix by applying an OKVS encoding algorithm to first data and hash data of the first data;
generating a vector or scalar parameters satisfying a preset linear equation using vector oblivious linear evaluation (VOLE) for a subspace based on Minicrypt, and distributing a preset first group and a preset second group among the parameters to a sender and a receiver, respectively;
instructing receiver to generate a masking matrix by masking the OKVS matrix to a first vector included in the first group and transmit the masking matrix to the sender;
instructing the sender to update one of the vectors included in the second group using the masking matrix; and
instructing the receiver to generate first comparison data by applying an OKVS decoding algorithm to a second vector included in the first group and the first data.

2. The method of claim 1, wherein the generating of the OKVS matrix comprises:
generating the OKVS matrix, the OKVS matrix being a binary matrix having a size of (1+ε)·n× [symbol] where n and [symbol] are natural numbers, and ε is a real number greater than or equal to 0, by applying the OKVS encoding algorithm to n pieces of first data having [symbol] bits and hash data obtained by applying a first hash function to the first data.

3. The method of claim 1, further comprising:
instructing the receiver to apply a linear code encoder to the OKVS matrix to convert the OKVS matrix into a linear matrix, the linear code being configured to perform a linear operation.

4. The method of claim 3, wherein the generating of the OKVS matrix comprises:
generating the OKVS matrix, the OKVS matrix being a binary matrix having a size of (1+ε)·n× [symbol] where n and [symbol] are natural numbers, and ε is a real number greater than or equal to 0, by applying the OKVS encoding algorithm to n pieces of first data having [symbol] bits and hash data obtained by applying a first hash function to the first data,
wherein the converting into the linear matrix comprises generating a linear matrix having a size of (1+ε)·n×nc by applying the linear code encoder to each row of the OKVS matrix, and
wherein parameters nc, kc, and dc are preset for the linear code encoder such that nc−kc= [symbol] such that each row in the linear matrix has at least dc elements having non-zero values, and such that dc is set to satisfy f×dc≥k for the number of bits (f) corresponding to a field including elements of the second vector and a security coefficient (k).

5. The method of claim 1, wherein the distributing comprises:
distributing the first group to the receiver and distributing the second group to the sender,
wherein the linear equation is V\vec{ }⊕W\vec{ }=Δ·U\vec{ }, where Δ is an element of a predefined field F, V and W are vectors including elements of the predefined field F, and U is a vector belonging to a subspace of a vector space where respective elements of the vector include elements of the predefined field F,
wherein the first group includes V and U, and
wherein the second group includes W and Δ.

6. The method of claim 5, wherein the transmitting the masking matrix to the sender comprises:
instructing the receiver to generate a vector Z, the vector Z being a masking matrix obtained by masking the vector U to the OKVS matrix using exclusive OR (XOR), and to transmit the vector Z to the sender.

7. The method of claim 6, wherein the updating comprises:
instructing the sender to update the vector W using the vector Z.

8. The method of claim 7, wherein the updating comprises:
updating the vector W using (W′)\vec{ }=W\vec{ }⊕Z\vec{ }·Diag(Δ), where W′ is the updated vector W, and Diag(Δ) is a diagonal matrix whose diagonal components including scalar values Δ.

9. The method of claim 5, wherein the generating of the first comparison data comprises:
instructing the receiver to generate the first comparison data by applying the first data and the vector V to the OKVS decoding algorithm.

10. The method of claim 1, further comprising:
instructing the sender to define a pseudo-random function based on the OKVS decoding algorithm using the updated vector; and
instructing the sender to apply second data of the sender and parameters in the second group to the pseudo-random function to generate second comparison data.

11. The method of claim 10, wherein the generating of the second comparison data comprises:
instructing the sender to define a pseudo-random function according to the OKVS decoding algorithm from a relationship between the vector V and the updated W′, responsive to the linear equation being V\vec{ }⊕W\vec{ }=Δ·U\vec{ }, where Δ is an element of a predefined field F, V and W are vectors including elements of the predefined field F, and U is a vector belonging to a subspace of a vector space where respective elements of the vector include the elements of the predefined field F, when the first group includes V and U, and when the second group includes W and Δ; and
instructing the sender to apply second data, Δ, and the updated W′ to the pseudo-random function to generate the second comparison data.

12. The method of claim 10, wherein the generating of the second comparison data comprises:
when the linear equation is V\vec{ }⊕W\vec{ }=Δ·U\vec{ }, where Δ is an element of a predefined field F, V and W are vectors include elements of the predefined field F, and U is a vector belonging to a subspace of a vector space where respective elements of the vector include the elements of the predefined field F, when the first group includes V and U, and when the second group includes W and Δ,
defining the pseudo-random function using:
$$PRF ( x ) := H 0 ( OKVS . Decode ( {W}^{′} , x ) + Δ \cdot C ( H ( x ) ) ) ,$$
where PRF( ) is the pseudo-random function, x is the second data, OKVS·Decode( ) is an OKVS decoding function, W′ is the updated vector W, C( ) is a linear matrix by a linear code encoder, H( ) is a first hash function, and H0( ) is a second hash function.

13. The method of claim 10, further comprising:
determining an intersection between the first data of the receiver and the second data of the sender using the first comparison data and the second comparison data.

14. A non-transitory computer-readable storage medium storing instructions that, when executed by the one or more processors, configure the one or more processors to perform the method of claim 1.

15. A receiver, the receiver comprising:
one or more processors configured to execute instructions;
a memory storing the instructions, which when executed by the processor configure the processor to:
generate an OKVS (oblivious key-value store) matrix by applying an OKVS encoding algorithm to first data and hash data of the first data;
apply a linear code encoder to the OKVS matrix to convert the OKVS matrix into a linear matrix including a linear code configured to perform a linear operation;
receive a preset first group distributed, among vector or scalar parameters responsive to the vector or scalar parameters satisfying a preset linear equation being generated using vector oblivious linear evaluation (VOLE) for a subspace based on Minicrypt;
generate a masking matrix by masking the linear matrix to a first vector included in the first group and transmitting the masking matrix to a sender; and
generate first comparison data by applying an OKVS decoding algorithm to a second vector included in the first group and the first data.

16. The receiver of claim 15, wherein the one or more processors are further configured to:
generate, when the linear equation is V\vec{ }⊕W\vec{ }=Δ·U\vec{ }, where Δ is an element of a predefined field F, V and W are vectors including elements of the predefined field F, and U is a vector belonging to a subspace of a vector space where respective elements of the vector include the elements of the predefined field F, and when the first group includes V and U, and a second group includes W and Δ, a vector Z, the vector Z being a masking matrix obtained by masking the vector U to the linear matrix using exclusive OR (XOR); and
transmit the vector Z to the sender.

17. The receiver of claim 16, wherein the one or more processors are further configured to:
generate the first comparison data by applying the first data and the vector V to the OKVS decoding algorithm.

18. A sender, the sender comprising:
one or more processors configured to execute instructions;
a memory storing the instructions, which when executed by the processor configure the processor to:
receive a preset second group distributed, among vector or scalar parameters responsive to the vector or scalar parameters satisfying a preset linear equation being generated using vector oblivious linear evaluation (VOLE) for a subspace based on Minicrypt;
update one vector of the vectors included in the second group using a masking matrix responsive to the masking matrix being obtained by masking a first vector included in a first group being received from a receiver; and
define a pseudo-random function according to an OKVS (oblivious key-value store) decoding algorithm using the updated one vector and apply second data and parameters in the second group to the pseudo-random function to generate second comparison data.

19. The sender of claim 18, wherein the one or more processors are further configured to:
update a vector W using (W′)\vec{ }=W\vec{ }⊕Z\vec{ }·Diag(Δ), where W′ is an updated vector W, Z is the masking matrix, and Diag(Δ) is a diagonal matrix having scalar values Δ, responsive to the linear equation being V\vec{ }⊕W\vec{ }=Δ·U\vec{ }, where Δ is an element of a predefined field F, V and W are vectors including elements of the predefined field F, and U is a vector belonging to a subspace of a vector space where respective elements of the U vector include the elements of the predefined field F, the first group includes V and U, and the second group includes W and Δ.

20. The sender of claim 19, wherein the one or more processors, in generating the second comparison data, are further configured to:
define the pseudo-random function using:
$$PRF ( x ) := H 0 ( OKVS . Decode ( {W}^{′} , x ) + Δ \cdot C ( H ( x ) ) ) ,$$
where PRF( ) is the pseudo-random function, x is the second data, OKVS·Decode( ) is an OKVS decoding function, W′ is the updated vector W, C( ) is a linear matrix, H( ) is a first hash function, and H0( ) is a second hash function.
